(19) United States
(12) Patent Application Publication
(10) Pub. No.: US 2005/0108721 A1
(43) Pub. Date: May 19, 2005

(54) Method of calling an export function stored in a shared library

(76) Inventors: Satoshi Oshima, Tachikawa (JP); Satoru Tomida, Seto (JP); Shinji Kimura, Sagamihara (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/762,368

(22) Filed: Jan. 23, 2004

(30) Foreign Application Priority Data
Nov. 17, 2003 (JP) 2003-386091

(51) Int. Cl. G06F 9/44

(52) U.S. Cl. 719/310

(57) ABSTRACT

A method for efficiently auditing a call to an export function in a shared library from an application program executed by a computer and the computer executing the method are provided. The call method hooks a shared library call by using an injection shared library for hooking the export function in the shared library, records shared library call information and audits the shared library call. It is therefore possible to filter a shared library call without modifying the shared library and to generate consistent records at high speed.

### BACKGROUND OF THE INVENTION

The present invention relates to a method of calling an export function stored in a shared library from an application program executed by a computer, and an apparatus like a computer for executing the method.

A general computer is constituted of a CPU, a memory, a storage, a communication apparatus, a keyboard, an input device such as a keyboard, a mouse, and a card reader, and an output device such as a display and a printer.

A storage stores therein software to be executed by a computer, such as an operating system (hereinafter abbreviated into an OS), an application, a shared library and the like.

Shared libraries are files or modules which collect routine procedures, i.e., functions and the like to be executed by various programs, the shared libraries being used for reducing the capacity of a computer storage or the use amount of a work memory, for reducing software version management procedures, or for reducing software development costs. Since shared libraries are shared by a plurality of programs, they are created, managed and retained independently from program main parts such as applications.

Shared libraries include static link libraries and dynamic link libraries, the former being linked to program main parts during program compiling and the latter being linked during program execution.

In most computers, an application specific area in a memory space is assigned to each application, for example, an application area 1 401, an application area 2 402 and an application area 3 403. OS commonly used for all processes is allocated to a memory region different from that for applications. This region is called a kernel region 407 which cannot be freely accessed by those applications which don't have specific privilege.

In this manner, each application can be prevented from being interfered or destroyed by some problems contained in other applications. In dynamic link libraries, execution code regions and regions for constants not changed during program execution, such as shared library regions 403, 405 and 406, are often shared by a plurality of processes under the control of OS, i.e., one shared library is mapped to a plurality of memory areas. In this case, it can be expected to reduce the memory use amount and shorten a program start-up time.

If OS restricts an access to the kernel region 407 from an application, the application generally issues a software interrupt to a program such as OS 201 during execution in the kernel region 407, before the application issues an access request (hereinafter called a system call) to the kernel region 407.

Some OS implements the system call not as the software interrupt to the kernel region 407 but as the dynamic link library. Specifically, when an application calls OS under execution in the kernel region 407, the application calls once a shared library to generate a software interrupt in the shared library and access the kernel region 407.

Jeffrey Richter “Advanced Windows” revised third edition, Microsoft® Press, discloses a technique of injection into a dynamic link library. With this method, such a call to a shared library from an application is captured (hereinafter called “hooked”) by a program (hereinafter called an “external program”) different from OS and applications associated with the interrupt, and the call content is recorded or filtered.

With the technique “injection”, an injection shared library 502 having the same export functions as those of a shared library as an injection object, i.e., a call object (hereinafter called a “injection objective shared library”) 503, is created and coupled to an application 501 (mapped to a memory space of the application), in place of the injection objective shared library. The injection shared library also performs a record process, an audit process or a rejection process relative a call to the shared library from an application. After this process, the injection shared library calls the shared library as the injection objective. With such design, the application can operate in such a manner that the system runs without the injection shared library.

### SUMMARY OF THE INVENTION

According to conventional techniques, each memory region such as a region 403 corresponding to the shared library is loaded in each corresponding memory region such as a region 401 of the application. This results in that a memory region where variables such as functions called from the shared library is a region specific to each application. For example, when a shared library call is recorded by using the injection shared library and if information such as information of variables to be recorded is stored in the memory region assigned to each application, in order to acquire the information the computer is required to switch the a virtual memory space to a memory space having the objective information by performing inter-process communications and memory space switching. This lowers the system performance. Since the program becomes complicated, the reliability lowers.

In order to overcome such disadvantages, it can be considered that a region commonly usable by applications is provided in the memory space in which the applications are loaded, and in this region, information such as information of variables used by the shared libraries is recorded. However, there is a possibility that the application is changed in the long term. In such a case, in order to perform a record process with consistency, it is necessary to provide a lock mechanism among applications. With the lock mechanism, if a record is required to be maintained often, the performance may be lowered, and if a plurality of locks are required to be acquired, a dead lock may occur and there is a danger that the system halts.

Consider now that the operation of a shared library is to be controlled, i.e., a variable is to be designated. Since a variable region of the shared library is provided separately for each application, it is necessary to incorporate the configuration that a shared region for files or the like is provided and operation commands are written in this region and that a shared library periodically refers to the shared region to receive an operation control command. However, a write operation for the shared region for files or the like takes a much longer time than using a system call. This poses a performance problem and an inability of file access depending upon the system conditions.

In order to solve the above-described problems, according to an aspect of the invention, a kernel region is provided with a shared region for an injection shared library and a region for supplying a command to a shared region, the injection shared library being used when the shared library hooks a call to an export function stored in the shared library from an application program executed by a computer.

According to another aspect of the invention, the kernel region includes a region for storing information of a criterion to be used when the injection shared library audits a call to an export function.

According to still another aspect of the invention, the kernel region includes a region for storing a history (hereinafter called a “log”) of calls to an export function in the shared library from each application.

Other objects, features and advantages of this invention will become apparent from the present specification and the description of the accompanying drawings.

According to the invention, a consistent log can be acquired when an access to an export function in a shared library is hooked and filtered without modifying the shared library.

### BRIEF DESCRIPTION OF THE DRAWINGS

FIG. 1 is a block diagram showing an example of the hardware structure of a computer to be used in practicing the present invention.

FIG. 2 is a diagram showing an example of the content of a storage shown in FIG. 1.

FIG. 3 is a diagram showing an example of the content of a storage shown in FIG. 1.

FIG. 4 is a diagram showing an example of a virtual space layout of a computer according to the prior art.

FIG. 5 is a diagram showing an example of a module layout in a virtual space of a computer according to the prior art.

FIG. 6 is a diagram showing an example of a virtual space layout of a computer according to an embodiment of the invention.

FIG. 7 is a flow chart illustrating a shared library call log acquiring and shared library call auditing procedure according to the embodiment of the invention.

FIG. 8 is a diagram showing an example of shared library call information according to the embodiment of the invention.

FIG. 9 is a table showing an example of audit policies according to the embodiment of the invention.

FIG. 10 is a flow chart illustrating the procedure of a control application which outputs an audit policy change command to a command reception region.

FIG. 11 is a diagram showing an example of a virtual space layout of a computer according to the embodiment of the invention.

### DESCRIPTION OF THE EMBODIMENTS

The outline of the embodiment of the present invention will be described with reference to the drawings.

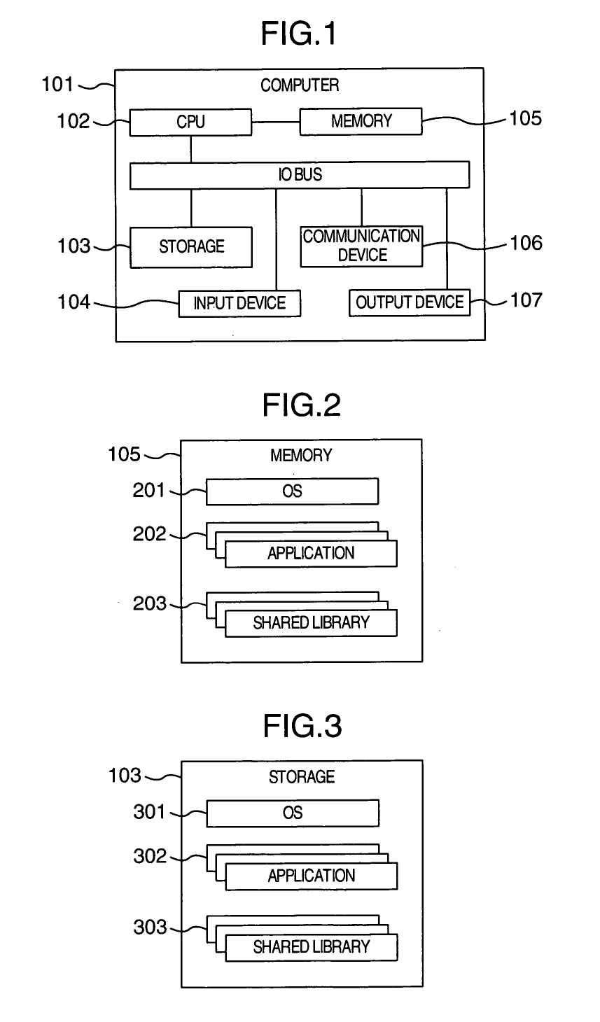

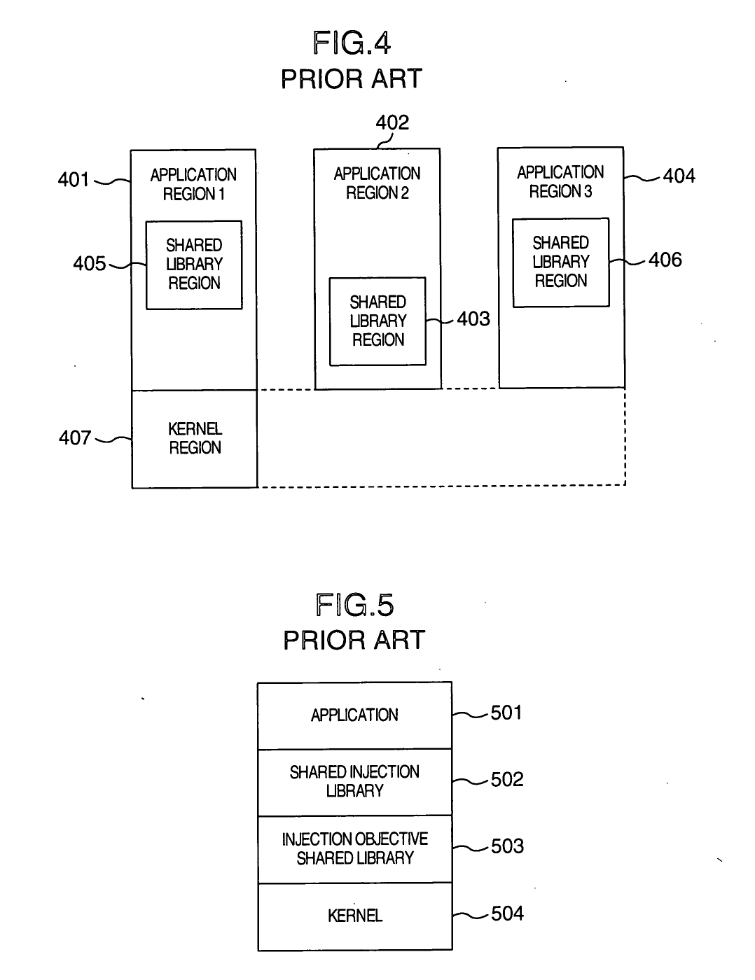

In this embodiment, a computer 101 shown in FIG. 1 includes, as its software programs: shared libraries; injection shared-libraries associated with the shared libraries and coupled to applications; a filter module disposed in a kernel region and performing a process of recording logs of the injection shared-libraries, a process of receiving commands from an administrator, a process of auditing shared library export calls, and other processes; and a control application for collecting output results which the injection shared-libraries outputs to a common region (hereinafter called a “kernel mode shared region”) in the kernel region, outputting the output results to files and reporting information to the administrator.

The injection shared library hooks a portion or the whole of accesses to the export functions possessed by the shared library serving as an injection objective.

The kernel mode shared region may be an extended region of the kernel region, a module dynamically added to the kernel, or a device driver operating in a kernel mode. An audit policy to be used for auditing a shared library call may be disposed in the kernel mode shared region.

In accordance with a periodical call or a call from the kernel mode shared region, the control application outputs the information recorded in the kernel mode shared region to a specific file and reports information to the administrator. A command to the injection shared library such as an instruction from the system administrator can be issued when the control application writes the command in a command reception region in the kernel mode shared region.

When an application issues a function call to the shared library, the call is hooked by the injection shared library and the control is passed to the injection shared library. The injection shared library can acquire information such as a call time, a calling user, a calling application and an argument passed at the call. The injection shared library records this information in the kernel mode shared region by issuing a system call to the filter module under execution in the kernel region. The filter module records the received information and audits whether the access is eligible or not in accordance with audit criteria. In this case, the filter module can read the contents of the command reception region to acquire logs and to control or not to control an access. If the access is judged from the audit criteria that it is not eligible, the access to the shared library is inhibited and only the access record is stored, i.e., so-called filtering of an access to the shared library can be performed.

The details of the embodiment will be described below with reference to the accompanying drawings.

FIG. 1 is a block diagram illustratively showing a computer according to the embodiment. The computer 101 has a CPU 102, a work memory 105, a storage 103, a communication device 106, an input device 104 such as a keyboard, a mouse and a card reader, and an output device 107 such as a display and a printer.

As shown in FIG. 3, the storage 103 stores software to be executed by the computer 101, such as an OS 301, applications 302 and shared libraries 303. A plurality of applications 302 and shared libraries 303 are often used. The storage 103 is a non-volatile storage such as a hard disk and a DVD.

When software is to be executed, as shown in FIG. 2 the computer 101 loads the OS 301, applications 302 and shared libraries 303 stored in the storage 103 into the volatile high-speed memory 105 as an OS 201, applications 202 and shared libraries 203, and CPU 102 executes the software. In the following, although the operation will be described from the view point of software, the operation is actually performed by CPU 102. Communication between software to be described below is performed by inter-program communication which is realized by recording a command in a designated memory region.

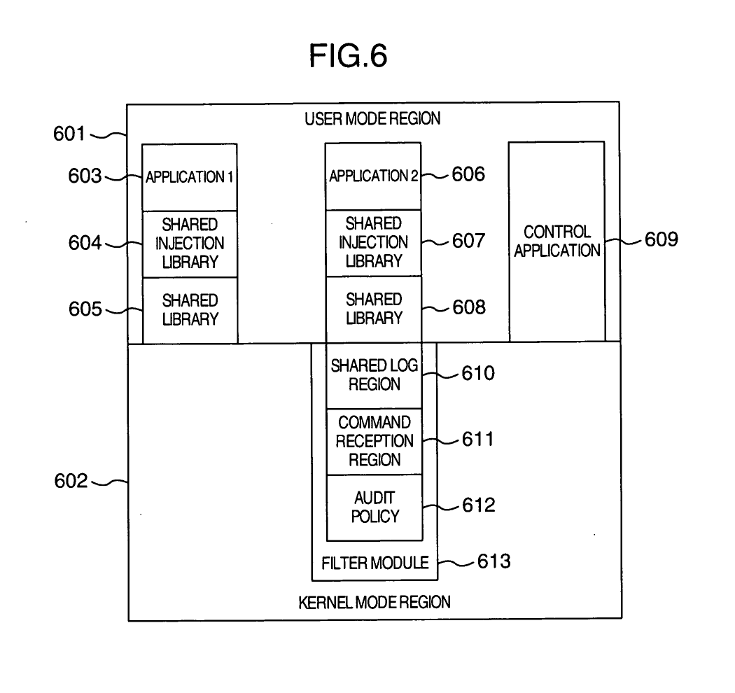

FIG. 6 is a diagram showing the software configuration of the computer 101 of this embodiment. General application programs such as an application program 1 603 and an application program 2 606 are stored in an application usable memory region (hereinafter called a “user mode region”) 601. The application programs 603 and 606 are linked to the injection shared-libraries 604 and 607 when they are compiled or executed.

The injection shared-libraries 604 and 607 are linked to shared libraries 605 and 608, respectively. A control application 609 is also loaded in the user mode region 601. Loaded in a kernel region 602 is a filter module 613 having a shared log region 610, a command reception region 611 and audit policies 612.

The application 1 603, injection shared library 604, shared library 605 and filter module 613 are disposed in the same virtual space. Similarly, the application 2 606, injection shared library 607, shared library 608 and filter module 613 are mapped in the same virtual space, and the control application 609 and filter module 613 are mapped in the same virtual space. The application 1, application 2 and control application 609 are not mapped at the same time.

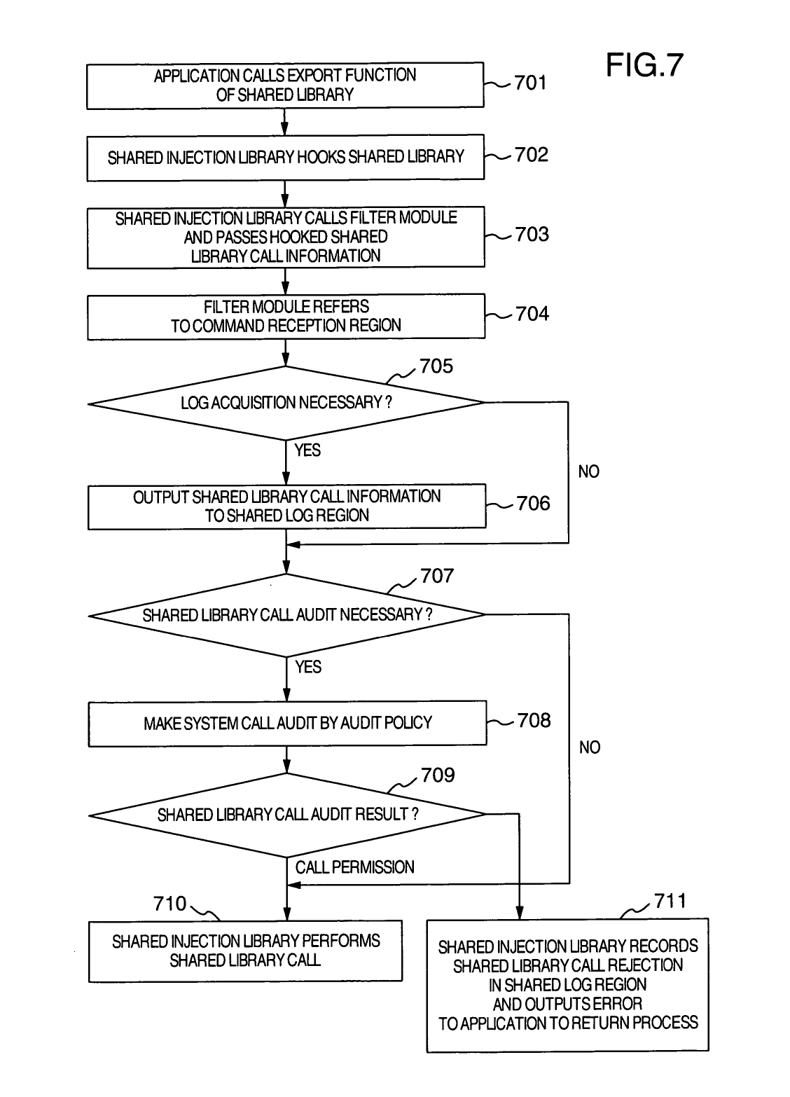

The procedure shown in FIG. 7 is performed when the application 1 603 and application 2 606 call the shared libraries 605 and 608 serving as an injection objective, respectively. The procedure shown in FIG. 7 will be described. In the following description, although only the application 1 will be described, other applications operate in a similar manner.

The application 1 calls an export function of the shared library 605 (Step 701). Upon reception of an export function call to the shared library 605, the injection shared library 604 hooks the call to the shared library 605 (Step 702). A particular hooking method may be a method of statically hooking the injection shared library upon compilation, a method of replacing a dynamic link library with an injection library, a method of hooking an access to an object export function by using an application executed in another application space.

The injection shared library 604 hooked the export function call calls the filter module 613 by using a system call to transmit the shared library call information contained in the hooked call to the filter module 613 (Step 703). The shared library call information will be later described.

The filter module 613 received the shared library call information refers to the command reception region 611 to read a command supplied from the control application (Step 704). The referred-to command is evaluated at a later step to determine the operation of the filter module 613.

In accordance with the command read from the command reception region 611, the filter module 613 determines whether the shared library call information is to be recorded in the shared log region 610. The shared library call information of each application is stored in the shared log region 610. It is therefore necessary to perform exclusive control of each application. The shared log region 610 may be assigned to each processor if the computer has a plurality of processors.

The acquired command may contain the conditions to be used when the shared library call information is recorded in the shared log region 610. The conditions include the type of an application which issued a call, a user using the application, the type of an export function called by the application, and the like. The filter module 613 determines from the conditions contained in the command whether the shared library call information is to be recorded or not (Step 705).

If it is judged at Step 705 that it is necessary to acquire a log, the filter module 613 outputs the shared library call information to a region dedicated to the application 1 in the shared log region 610 (Step 706).

Thereafter, in accordance with the command acquired from the command reception region 611, the filter module 613 determines whether the export function call to the shared library is to be audited or not. The command acquired from the command reception region 611 may contain the conditions to be used when the call audit is executed. The conditions include the type of an application which issued a call, a user using the application, the type of an export function called by the application, and the like. The filter module 613 determines from the conditions contained in the command whether the call audit is to be performed or not (Step 707).

If it is judged at Step 707 that an audit for the shared library call is required, the filter module 613 audits, in accordance with audit policies 612 to be later described, whether the shared library call information transmitted from the injection shared library 604 to the filter module 613 is eligible or not (Step 708).

Thereafter, the filter module 613 judges the result of the shared library call audit performed at Step 708 (Step 709).

If the call is permitted or if it is judged at Step 707 that the shared library call audit is not necessary, the injection shared library 604 received this notice from the filter module 613 issues an export function call to the shared library 605. The injection shared library 604 has made injection relative to a particular export function in the shared library 605, and has received from the application 1 a function argument to be transmitted to the export function of the shared library 605 hooked by the injection shared library 604, as the shared library call information. Therefore, by using the information including such an argument, the injection shared library 604 can call the export function of the shared library 605 serving as an injection objective, as well as the proper argument.

The injection shared library 604 called the export function from the shared library 605 transmits the results to the application.

If the shared library call audit does not permit the call, the filter module 613 returns an error to the application after the type of the call rejected, the reason of rejection and the like are recorded in the shared log region 610. There are some methods other than the error return method. Namely, a normal completion is returned to the application without calling the shared library 605. Alternatively, the filter module 613 changes the rejected call to a call capable of being permitted to call the shared library 605, i.e., changes the argument used for the call to an argument capable of being permitted, and then the injection shared library calls the shared library (Step 711).

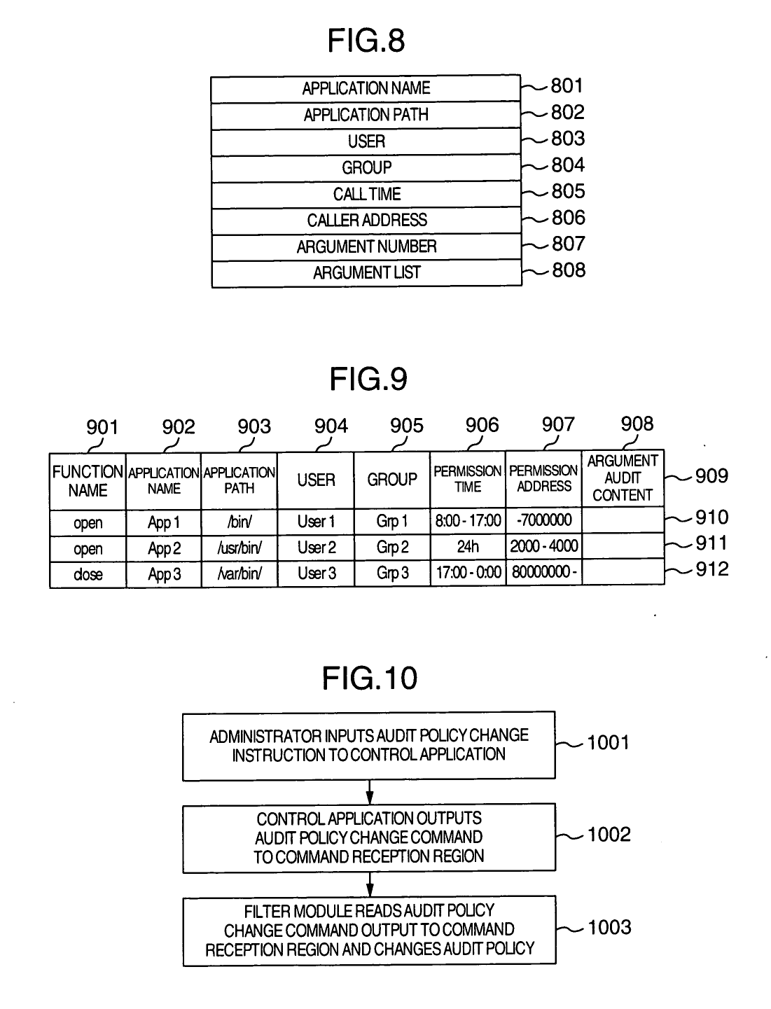

FIG. 8 is a diagram showing an example of the shared library call information to be transmitted from the injection shared library to the filter module at Step 703. The shared library call information contains: an application name 801 representative of the application 603 as a shared library caller; an application path 802 indicating a storage location of the application 603 in a file system formed in the storage 103; a user 803 representative of the user executing the application; a group 804 representative of the group to which the user executing the application belongs; a call time 805 representative of the time when the shared library was called; a caller address 806 representative of a call location in the application; an argument number 807 representative of the number of arguments passed when the application called the shared library; and an argument list 808 indicating the contents of the arguments passed when the application called the shared library.

FIG. 9 is a diagram showing an example of audit policies stored in the audit policy field 612 and used for the shared library call audit. The audit policies are prepared at least as many as the number of shared libraries serving as an injection object.

A column 901 registers the name of an export function of the shared library to be audited. The items designated in the following columns constitute the conditions of permission of a call to the function designated in the column 901.

A column 902 registers the name of an application which is permitted to call the function designated in the column 901. In addition to a particular application name, a symbol representative of an application group may be used to simplify the notation of the application which is permitted to access.

A column 903 registers an application path indicating the location in the file system stored in which is the application which is permitted to call the function designated in the column 901. An access can be permitted by designating a desired application disposed on a specific path by combining the information registered in the column 902.

A column 904 registers information representative of a user permitted to call the function designated in the column 901. The description of a user may be simplified by registering a symbol representative of a user group instead of a particular user name.

A column 905 registers information representative of a group belongs to which is the user permitted to call the function designated in the column 901. An access can be permitted by a desired user belonging to a specific group by combining the information registered in the column 904.

A column 906 registers information representative of a time or a time range when or while the function designated in the column 901 is permitted to be accessed.

A column 907 registers information representative of an address at which the function designated in the column 901 is permitted to be accessed. By using this address, a call in a particular address range may be permitted, a call only in a code range may be permitted, or a call in a stack region may be rejected.

A column 908 registers argument auditing policies to be used when the call to the function designated in the column 901 is audited. For example, if a first argument is “80”, the audit content of rejecting the access is described. In another embodiment of the audit policy, the audit policy column 908 designates an access audit module provided externally, i.e., functionally added to the injection shared library 604.

The audit condition may be additionally provided when necessary.

In the audit process for the function designated in the column 901 by utilizing the audit policy, a call to the shared library by the application is permitted only when all the audit conditions designated in the columns 902 to 908 are satisfied.

In the computer of this embodiment, the control application 609 changes the settings of the filter module 613 such as the audit policy 612. More specifically, when the behavior of the filter module 613 is to be changed, the administrator writes change information in the command reception region 611 by using the control application 609. With reference to FIG. 10, description will be made on the procedure of renewing or updating, for example, the audit policy 612 during the system operation.

An administrator inputs an audit policy change instruction to the control application 609 (Step 1001). Upon reception of the audit policy change instruction from the administrator, the control application 609 outputs an audit policy change command to the command reception region 611 in the filter module 613 (Step 1002). Thereafter, the filter module 613 reads the audit policy change command output from the control application 609 from the command reception region 611, and changes the audit policy 612 in accordance with the command (Step 1003).

In addition to instructing a change of the audit policy 612, the administrator can instruct an operation start and end of the filter module 613 by using the control application 609.

Next, description will be made of the embodiment applied to software which improves computer security.

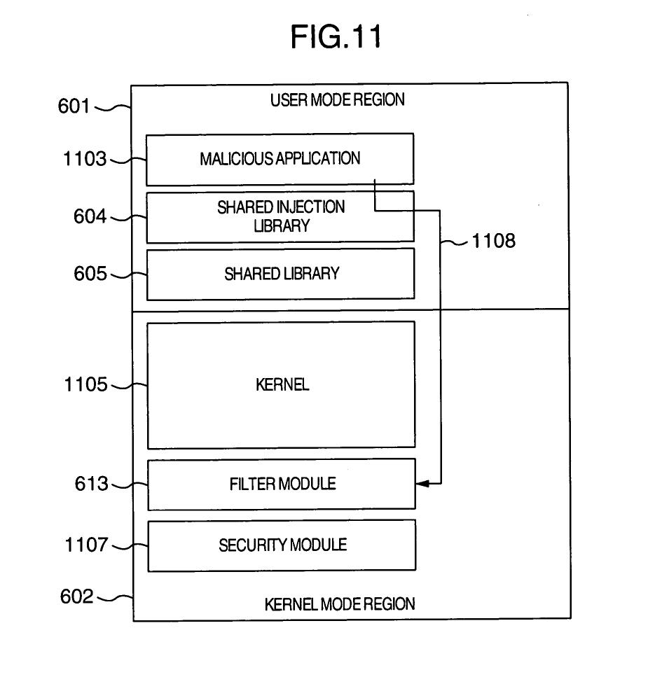

FIG. 11 is a block diagram showing an example of the configuration of security improving software applied to the embodiment, the software being provided by a security module added to the kernel region 602. A security module 1107 is required to be always resident in the kernel region 602 in order to retain security. However, in order to make the security module 1107 be resident in the kernel region 602, it is required to have the same function as that of a general kernel module. In this case, if a malicious application program 1103 can acquire a proper privilege, it can call the shared library 605 to invalidate, i.e., unload or inactivate, the security module 1107.

However, by applying this embodiment, as indicated by an arrow 1108 in FIG. 11, before the malicious application 1103 accesses the shared library 605, the injection shared library 604 notifies the access to the filter module 613. The filter module 613 operates to make the malicious application not invalidate the security module 1107, in accordance with the audit policy set to the filter module. In this manner, it is possible to prevent undesired security module invalidation.

As described above, since the filter module is loaded in the kernel region, a request such as an access request to the shared library from the injection shared library becomes one type of the system call to the filter module. It is therefore unnecessary to introduce a lock mechanism in the computer. Furthermore, since a log of each application is managed in the kernel region, it is possible to maintain consistency of processed information. A process speed can be improved since the system call is used for acquiring the log information.

It should be further understood by those skilled in the art that although the foregoing description has been made on embodiments of the invention, the invention is not limited thereto and various changes and modifications may be made without departing from the spirit of the invention and the scope of the appended claims.

1. A shared library call method for a computer for executing an operating system which loads application programs and shared libraries in the same virtual space and manages a memory so as to make each application program have a specific virtual space, said method comprising the steps of:
hooking a call to a function in said shared library from said application program, the call being hooked by an injection shared library;
in response to hooking the call, calling a module stored in a kernel region of said memory; and
executing at least one process in accordance with information set in said called module, and thereafter calling the function in said shared library.

2. The shared library call method according to claim 1, wherein said module records a content of said hooked call to said shared library in said kernel region.

3. The shared library call method according to claim 2, wherein said module audits the content of said hooked call in accordance with a predetermined policy and determines whether the hooked call to said shared library is to be permitted or not.

4. The shared library call method according to claim 3, wherein a result of the determination of permission or not is recorded in said kernel region.

5. The shared library call method according to claim 4, wherein a region where said call content is recorded in said kernel region is prepared for each of a plurality of processors.

6. The shared library call method according to claim 5, wherein a control application is provided for acquiring said call content recorded in said kernel region.

7. The shared library call method according to claim 6, further comprising the steps of:
issuing a command of changing settings in said module from said control application;
storing said issued command in a predetermined region in said kernel region; and
changing the settings in accordance with the command stored in said predetermined region, the settings being changed by said module.

8. The shared library call method according to claim 7, further comprising the steps of:
issuing a command of setting said auditing policy from said control application;
storing said issued command in a predetermined region in said kernel region; and
setting said auditing policy in accordance with said command stored in said predetermined region, said auditing policy being set by said module.

9. A computer for executing an operating system which loads application programs and shared libraries in the same virtual space and manages a memory so as to make each application program have a specific virtual space, comprising:
hooking means for hooking a call to a function in said shared library from said application program, the call being hooked by an injection shared library;
module calling means responsive to hooking of the call for calling a module stored in a kernel region of said memory; and
means for executing a predetermined process in accordance with information set in said module called by said module calling means, and calling the function in said shared library in accordance with a result of said process.

10. The computer according to claim 9, wherein said module stored in said kernel region includes a filter module, and said filter module records shared library call information and audits the shared library call.
